(19) United States
(12) Patent Application Publication
(10) Pub. No.: US 2024/0289176 A1
(43) Pub. Date: Aug. 29, 2024

(54) SYSTEMS AND METHODS FOR DISTRIBUTING WORKLOADS ACROSS DEVICES BASED ON NETWORK CONDITIONS

(71) Applicant: Dell Products, L.P., Round Rock, TX (US)

(72) Inventors: Michael S. Gatson, Austin, TX (US); Ankit Kumar, Bengaluru (IN); Srinivasa Ragavan, Bangalore (IN)

(73) Assignee: Dell Products, L.P., Round Rock, TX (US)

(21) Appl. No.: 18/173,414

(22) Filed: Feb. 23, 2023

(51) Int. Cl. G06F 9/50

(52) U.S. Cl. CPC G06F 9/505

(57) ABSTRACT

Systems and methods for distributing workloads across devices based on network conditions are described. In an illustrative, non-limiting embodiment an Information Handling System (IHS) of a workspace orchestration service obtains, from host IHSs, specifications of the respective host IHSs, where a first host IHSs hosts a plurality of workloads. The workspace orchestration service also obtains, from one or more of the host IHSs including a second host IHS, a respective one or more network connectivity parameters of the one or more host IHSs, including at least one network connectivity parameter from the second host IHS. The workspace orchestration service transitions one or more of the plurality of workloads from the first host IHS to the second host IHS based, at least in part, on the specifications of the first and second host IHSs, and the network connectivity parameters of the second host IHSs.

### FIELD

This disclosure relates generally to Information Handling Systems (IHSs), more specifically to workspace orchestration, and particularly to distributing workloads across devices based on network conditions.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. Variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Organizations may own and/or manage large numbers of IHSs. For instance, an employer may provide laptop computers to employees and may also operate various other types of IHSs, such as rack-mounted servers and networking equipment, in order to support operation of the laptops. The provided laptops may be operated in a variety of scenarios, both for performing job functions and for personal use. In another example, educational institutions may support various types of IHSs, such as tablets and laptops, that are issued to students and employees. Medical institutions may also support a variety of IHSs that may be used by patients, visitors and/or staff. In all such instances, the users and IHSs that are being supported is continually in flux.

Many IHSs, such as laptops and tablets, are portable and are commonly used in different locations, even if different locations within a single building or residence. Portable IHSs may be used in public locations, and may thus be regularly used in a variety of different public and private locations. Based on such changes in location, an IHS may be coupled to different external devices, such as a laptop being docked at different workstations. In some instances, the external devices that may be occasionally connected to an IHS may include both public and private devices, such as use of an IHS while coupled to a home office workstation and use of the IHS at an airport, hotel, or corporate shared-use workstation. Organizations seeking to provide IHS users with access data must be prepared to do so in a wide variety of operational scenarios.

### SUMMARY

Systems and methods for distributing workloads across devices based on network conditions are described. In an illustrative, non-limiting embodiment an Information Handling System (IHS) of a workspace orchestration service includes a processor; and a memory coupled to the processor, the memory having program instructions stored thereon that, upon execution, cause the processor to: obtain, from a plurality of host IHSs, a respective plurality of specifications of the respective host IHSs, wherein a first host IHSs of the plurality of host IHSs hosts a plurality of workloads; obtain, from one or more of the plurality of host IHSs including a second host IHS of the plurality of host IHSs, a respective one or more network connectivity parameters of the one or more host IHSs, including at least one network connectivity parameter from the second host IHS; and transition one or more of the plurality of workloads from the first host IHS to the second host IHS based, at least in part, on the specifications of the first and second host IHSs, and the network connectivity parameters of the second host IHSs.

In some embodiments, the network connectivity parameters comprise at least one of: network connection status, network connection type, network connection speed, network latency in receiving responses, or a frequency of network connection drops. In some embodiments, the specifications comprise at least one of: hardware characteristics, application provenance, IHS operating system, form factors, supported peripherals, hardware resources, UEFI Secure Boot capabilities, monitor privacy filter characteristics, protected private regions of memory, security sandbox information, role-based access control information, or data regarding workloads hosted by the IHS.

In some embodiments, the plurality of workloads hosted by the first host IHS include a workspace of the first host IHS. In some of these embodiments, the workspace of the first host IHS is planned and deployed by an Information Technology Decision Maker (ITDM).

In some embodiments, in order to obtain, from the one or more host IHSs the respective one or more network connectivity parameters of the one or more host IHSs, the program instructions further cause the processor of the IHS of the workspace orchestration service to: obtain, from the first host IHS, at least one network connectivity parameter of the first host IHS; and in order to transition the one or more of the plurality of workloads from the first host IHS to the second host IHS, the program instructions further cause the processor of the IHS of the workspace orchestration service to: determine that the one or more of the plurality of workloads should transition from the first host IHS to the second host IHS based, at least in part, on the specifications of the first and second host IHSs, the at least one network connectivity parameter of the first host IHSs, and the at least one network connectivity parameter of the second host IHSs; and transition, based at least in part on the determination, the one or more of the plurality of workloads from the first host IHS to the second host IHS.

In some embodiments, in order to transition the one or more of the plurality of workloads from the first host IHS to the second host IHS, the program instructions further cause the processor of the IHS of the workspace orchestration service to: obtain, from an agent of the first host IHS, information regarding a need to transfer at least one workload of the plurality of workloads of the first host IHS to a different IHS; and transition, based at least in part on the obtained information, the specifications of the first and second host IHSs, and the network connectivity parameters of the second host IHSs, the one or more workloads from the first host IHS to the second host IHS.

In some embodiments, the specifications of the first host IHS include data regarding the plurality of workloads hosted by the first host IHS, and in order to transition the one or more of the plurality of workloads from the first host IHS to the second host IHS, the program instructions further cause the processor of the IHS of the workspace orchestration service to: determine workload compatibility of the plurality of workloads with the second host IHS based, at least in part, on the data regarding the plurality of workloads hosted by the first host IHS and the specifications of the second host IHSs; and transition, based, at least in part, on the determination and the network connectivity parameters of the second host IHSs, the one or more workloads from the first host IHS to the second host IHS.

In some embodiments, the specifications of the first host IHS include data regarding the plurality of workloads hosted by the first host IHS, and in order to transition the one or more of the plurality of workloads from the first host IHS to the second host IHS, the program instructions further cause the processor of the IHS of the workspace orchestration service to: determine that at least one of the plurality of workloads hosted by the first host IHS is not compatible with the second host IHS based, at least in part, on the data regarding the plurality of workloads hosted by the first host IHS and the specifications of the second host IHSs; and fail to transition, based at least in part on the determination, the at least one workload from the first host IHS to the second host IHS.

In some embodiments, the plurality of workloads hosted by the first host IHS include a workspace of the first host IHS, and in order to transition the one or more of the plurality of workloads from the first host IHS to the second host IHS, the program instructions further cause the processor of the IHS of the workspace orchestration service to: transition the entire workspace of the first host IHS to the second host IHS.

In another illustrative, non-limiting embodiment, a method for distributing workloads across devices based on network conditions may include: obtaining, from a plurality of host Information Handling Systems (IHSs), a respective plurality of specifications of the respective host IHSs, including specifications of a first host IHS and specifications of a second host IHS, wherein the first host IHSs hosts a plurality of workloads; obtaining, from one or more of the plurality of host IHSs including the second host IHS, a respective one or more network connectivity parameters of the one or more host IHSs, including at least one network connectivity parameter from the second host IHS; and transitioning one or more of the plurality of workloads from the first host IHS to the second host IHS based, at least in part, on the specifications of the first host IHS, the specifications of the second host IHS, and the network connectivity parameters of the second host IHS.

In some embodiments, the plurality of workloads hosted by the first host IHS include a workspace of the first host IHS, and the workspace of the first host IHS is planned and deployed by an Information Technology Decision Maker (ITDM). In some embodiments, the obtaining, from the one or more host IHSs the respective one or more network connectivity parameters of the one or more host IHSs, further includes: obtaining, from the first host IHS, at least one network connectivity parameter of the first host IHS. In some of these embodiments, the transitioning the one or more of the plurality of workloads, from the first host IHS to the second host IHS, further includes: determining that the one or more of the plurality of workloads should transition from the first host IHS to the second host IHS based, at least in part, on the specifications of the first and second host IHSs, the at least one network connectivity parameter of the first host IHSs, and the at least one network connectivity parameter of the second host IHSs; and transitioning, based at least in part on the determination, the one or more of the plurality of workloads from the first host IHS to the second host IHS.

In some embodiments, the transitioning the one or more of the plurality of workloads from the first host IHS to the second host IHS further includes: obtaining, from an agent of the first host IHS, information regarding a need to transfer at least one workload of the plurality of workloads of the first host IHS to a different IHS; and transitioning, based at least in part on the obtained information, the specifications of the first and second host IHSs, and the network connectivity parameters of the second host IHSs, the one or more workloads from the first host IHS to the second host IHS.

In some embodiments, the specifications of the first host IHS include data regarding the plurality of workloads hosted by the first host IHS, and the transitioning the one or more of the plurality of workloads from the first host IHS to the second host IHS further includes: determining workload compatibility of the plurality of workloads with the second host IHS based, at least in part, on the data regarding the plurality of workloads hosted by the first host IHS and the specifications of the second host IHSs; and transitioning, based, at least in part, on the determination of workload capability, and the network connectivity parameters of the second host IHSs, the one or more workloads from the first host IHS to the second host IHS.

In some embodiments, the specifications of the first host IHS include data regarding the plurality of workloads hosted by the first host IHS, and the transitioning the one or more of the plurality of workloads from the first host IHS to the second host IHS further includes: determining that at least one of the plurality of workloads hosted by the first host IHS is not compatible with the second host IHS based, at least in part, on the data regarding the plurality of workloads hosted by the first host IHS and the specifications of the second host IHSs; and failing to transition, based at least in part on the determination, the at least one workload from the first host IHS to the second host IHS.

In some embodiments, the plurality of workloads hosted by the first host IHS include a workspace of the first host IHS, and wherein the transitioning the one or more of the plurality of workloads from the first host IHS to the second host IHS further includes: transitioning the entire workspace of the first host IHS to the second host IHS.

In another illustrative, non-limiting embodiment, a memory storage device has program instructions stored thereon that, upon execution by one or more Information Handling Systems (IHSs), cause the one or more IHSs to: obtain, from a plurality of host IHSs, a respective plurality of specifications of the respective host IHSs, including specifications of a first host IHS and specifications of a second host IHS, wherein the first host IHSs hosts a plurality of workloads; obtain, from one or more of the plurality of host IHSs including the second host IHS, a respective one or more network connectivity parameters of the one or more host IHSs, including at least one network connectivity parameter from the second host IHS; and transition one or more of the plurality of workloads from the first host IHS to the second host IHS based, at least in part, on the specifications of the first host IHS, the specifications of the second host IHS, and the network connectivity parameters of the second host IHS.

In some embodiments, to obtain, from the one or more host IHSs the respective one or more network connectivity parameters of the one or more host IHSs, the program instructions further cause the one or more IHSs to: obtain, from the first host IHS, at least one network connectivity parameter of the first host IHS. In some of these embodiments, to transition the one or more of the plurality of workloads from the first host IHS to the second host IHS, the program instructions further cause the one or more IHSs to: determine that the one or more of the plurality of workloads should transition from the first host IHS to the second host IHS based, at least in part, on the specifications of the first and second host IHSs, the at least one network connectivity parameter of the first host IHSs, and the at least one network connectivity parameter of the second host IHSs; and transition, based at least in part on the determination, the one or more of the plurality of workloads from the first host IHS to the second host IHS.

In some embodiments, to transition the one or more of the plurality of workloads from the first host IHS to the second host IHS, the program instructions further cause the one or more IHSs to: obtain, from an agent of the first host IHS, information regarding a need to transfer at least one workload of the plurality of workloads of the first host IHS to a different IHS; and transition, based at least in part on the obtained information, the specifications of the first and second host IHSs, and the network connectivity parameters of the second host IHSs, the one or more workloads from the first host IHS to the second host IHS.

In some embodiments, the specifications of the first host IHS include data regarding the plurality of workloads hosted by the first host IHS, and wherein to transition the one or more of the plurality of workloads from the first host IHS to the second host IHS, the program instructions further cause the one or more IHSs to: determine workload compatibility of the plurality of workloads with the second host IHS based, at least in part, on the data regarding the plurality of workloads hosted by the first host IHS and the specifications of the second host IHSs; and transition, based, at least in part, on the determination and the network connectivity parameters of the second host IHSs, the one or more workloads from the first host IHS to the second host IHS.

In some embodiments, the specifications of the first host IHS include data regarding the plurality of workloads hosted by the first host IHS, and wherein to transition the one or more of the plurality of workloads from the first host IHS to the second host IHS, the program instructions further cause the one or more IHSs to: determine that at least one of the plurality of workloads hosted by the first host IHS is not compatible with the second host IHS based, at least in part, on the data regarding the plurality of workloads hosted by the first host IHS and the specifications of the second host IHSs; and fail to transition, based at least in part on the determination, the at least one workload from the first host IHS to the second host IHS.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 is a diagram depicting illustrative components of an Information Handling System (IHS) configured, according to various embodiments, to support workspaces operating on the IHS.

FIGS. 2A and 2B are, together, a diagram depicting a method, according to various embodiments, for orchestrating the deployment and operation of workspaces on an IHS.

FIG. 3 is a diagram depicting an end-user workspace view with list of workloads running on an end-user laptop, and an end-user mobile device, according to some embodiments.

FIG. 4 is a diagram depicting a cloud management orchestrating workloads across multiple IHSs of a single user, according to some embodiments.

FIG. 5 is a diagram generally depicting various trigger conditions for an IHS controller service to trigger a workspace transition via a cloud orchestrator service, according to some embodiments.

FIG. 6 is a system architecture block diagram generally depicting two client IHSs whose workloads are orchestrated by a workspace orchestration service, according to some embodiments.

FIG. 7 is an operational flowchart diagram depicting a more detailed implementation of distributing workloads from IHS-1 to IHS-2 based on network conditions, according to some embodiments.

### DETAILED DESCRIPTION

Some embodiments of the systems and methods for distributing workloads across devices based on network conditions provide for workload transition from one supported IHS device to another device (or devices) based on network capabilities and workloads. Some of these embodiments provide the ability to determine a better IHS device based on workloads and network capabilities for transition. Some of these embodiments provide for network capability optimizations taking into account the overhead for resolving application mismatches.

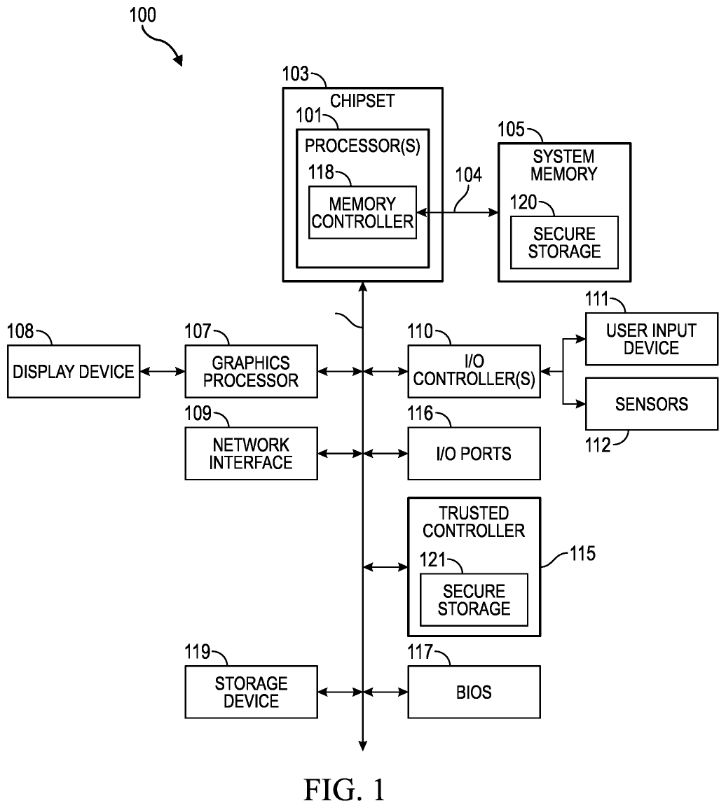

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An example of an IHS is described in more detail below. FIG. 1 shows various internal components of an IHS configured to implement certain of the described embodiments. It should be appreciated that although certain embodiments described herein may be discussed in the context of a personal computing device, such as laptop computers, other embodiments may utilize various other types of IHSs, such as rack-mounted servers.

FIG. 1 is a diagram depicting illustrative components of an Information Handling System (IHS) 100 configured, according to various embodiments, to support workspaces operating on the IHS. In some embodiments, IHS 100 may be employed to instantiate, manage, and/or terminate a workspace, such as a secure environment that may provide the user of IHS 100 with access to enterprise data while isolating the enterprise data from an Operating System (OS) and/or other applications executed by IHS 100. A workspace may operate using a variety of different configurations of the hardware and software resources of the IHS 100, where the resources that are used may be selected based on the security and risk context of a request to access protected data. A variety workspace topologies may be supported using the available computing resources of the IHS 100, including computing resources of external devices coupled to the IHS. Based on the current risk and security context in which an IHS 100 is operating, embodiments may switch between use of different workspace topologies that are supported by an IHS.

As shown in FIG. 1, IHS 100 includes one or more processor(s) 101, such as a Central Processing Unit (CPU), operable to execute code retrieved from system memory 105. Although IHS 100 is illustrated with a single processor, other embodiments may include two or more processors, that may each be configured identically, or to provide specialized processing functions. Processor(s) 101 may include any processor capable of executing program instructions, such as an INTEL PENTIUM series processor or any general-purpose or embedded processors implementing any of a variety of Instruction Set Architectures (ISAs), such as the x86, POWERPC®, ARM®, SPARC®, or MIPS® ISAs. In the embodiment of FIG. 1, processor(s) 101 includes an integrated memory controller 118 that may be implemented directly within the circuitry of processor(s) 101, or memory controller 118 may be a separate integrated circuit that is located on the same die as processor(s) 101. Memory controller 118 may be configured to manage the transfer of data to and from system memory 105 of IHS 100 via high-speed memory interface 104.

System memory 105 that is coupled to processor(s) 101 via memory bus 104 provides processor(s) 101 with a high-speed memory that may be used in the execution of computer program instructions by processor(s) 101. Accordingly, system memory 105 may include memory components, such as such as static RAM (SRAM), dynamic RAM (DRAM), NAND Flash memory, suitable for supporting high-speed memory operations by processor(s) 101. In some embodiments, system memory 105 may combine both persistent, non-volatile memory and volatile memory.

In certain embodiments, system memory 105 includes secure storage 120 that may be a segregated and protected portion of the system memory designated for storage of information, such as access policies, component signatures, encryption keys, and other cryptographic information, for use in hosting a secure workspace on IHS 100. In such embodiments, a signature may be calculated based on the contents of secure storage 120 and stored as a reference signature. The integrity of the data stored in secure storage 120 may then be validated at a later time by recalculating this signature of the contents of the secure storage and comparing the recalculated signature against the reference signature.

IHS 100 utilizes chipset 103 that may include one or more integrated circuits that are coupled to processor(s) 101. In the embodiment of FIG. 1, processor(s) 101 is depicted as a component of chipset 103. In other embodiments, all of chipset 103, or portions of chipset 108 may be implemented directly within the integrated circuitry of processor(s) 101. Chipset 103 provides processor(s) 101 with access to a variety of resources accessible via bus 102. In IHS 100, bus 102 is illustrated as a single element. However, other implementations may utilize any number of buses to provide the illustrated pathways served by bus 102.

As illustrated, a variety of resources may be coupled to processor(s) 101 of IHS 100 through chipset 103. For instance, chipset 103 may be coupled to network interface 109, such as provided by a Network Interface Controller (NIC) that is coupled to IHS 100 and allows IHS 100 to communicate via a network, such as the Internet or a LAN. Network interface device 109 may provide IHS 100 with wired and/or wireless network connections via a variety of network technologies, such as wireless cellular or mobile networks (CDMA, TDMA, LTE etc.), WIFI and BLUETOOTH. As described in additional detail below, in certain embodiments, network interface 109 may support connections between a trusted IHS component, such as trusted controller 115, and a remote orchestration service. In such embodiments, a connection supported by network interface 109 between the remote orchestration service and the trusted component may be considered an out-of-band (OOB) connection that is isolated from the OS of the IHS. In some embodiments, an OOB connection supported by network interface 109 may support a variety of remote management operations by trusted controller 115, including providing remote management of IHS 100 and/or of hardware components installed in IHS 100. As described in additional detail below, embodiments of IHS 100 may utilize OOB connections to interface with multiple remote orchestration services that may each provide different types of support for workspaces operating on IHS 100.

Chipset 102 of IHS 100 may also provide access to one or more display device(s) 108 via graphics processor 107. In certain embodiments, graphics processor 107 may be comprised within one or more video or graphics cards or an embedded controller installed as components of IHS 100. Graphics processor 107 may generate display information and provide the generated information to one or more display device(s) 108 coupled to IHS 100, where display device(s) 108 may include integrated display devices and/or external display devices 122G coupled to IHS, such as via an I/O port 116, where display device(s) 108 may include integrated display devices and/or external display devices coupled to IHS. In certain embodiments, graphics processor 107 may be integrated within processor 101. The one or more display devices 108 coupled to IHS 100 may utilize LCD, LED, OLED, or other thin film display technologies. Each display device 108 may be capable of touch input such as via a touch controller that may be an embedded component of display device 108, graphics processor 107, or a separate component of IHS 100 accessed via bus 102. In some embodiments, an external display device 122G coupled to IHS may include discrete logic and memory resources that may be used in the operation of a workspace. In some scenarios, an external display device 122G coupled to IHS 100 may be a public or shared-use display monitor, such as provided to the user of IHS 100 via a shared or public workstation.

In certain embodiments, chipset 103 may utilize one or more I/O controllers 110 to access hardware components such as user input devices 111 and sensors 112. For instance, I/O controller 110 may provide access to user-input devices 111 such as a keyboard 122B, mouse 122D, touchpad, touchscreen and/or other peripheral input devices. User input devices 111 may interface with I/O controller 110 through wired or wireless connections. In some embodiments, any or all of the user-input devices 111 coupled to IHS may be discrete devices with their own logic and memory resources that may be used in the operation of a workspace. In some scenarios, user-input devices 111 coupled to IHS 100 may be a public or shared-use devices, such as a keyboard 122B and mouse 122D of a shared or public workstation.

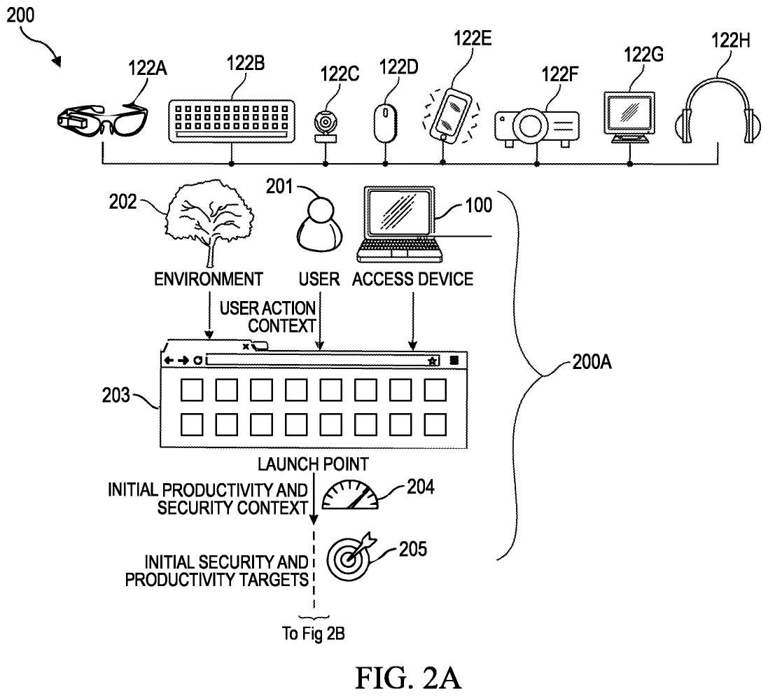

As indicated in FIG. 2A, a variety of external devices 122A-H may be coupled to IHS 100, such as via I/O ports supported by I/O controllers 110 and/or via network interface 109. The external devices may include user-input devices, such as a mouse 122D, camera 122C or keyboard 122B, user-output devices, such as an HMD 122A, external display 122G, projector 122F or headphones 122H. In some instances, an external device coupled to IHS 100 may include standalone IHS, such as a mobile cellular device 122E that may be coupled to the IHS via a wired or wireless connection.

Sensors 112 accessed via I/O controllers 110 may provide access to data describing environmental and operating conditions of IHS 100 (e.g., accelerometers, gyroscopes, hinge sensors, rotation sensors, hall effect sensors, temperature sensors, voltage sensors, sensors, IR sensors, photosensors, proximity sensors, distance sensors, magnetic sensors, microphones, ultrasonic sensors, etc.). In some embodiments, any or all of the sensors 112 coupled to IHS may be discrete devices with their own logic and memory resources that may be used in the operation of a workspace.

In some cases, chipset 103 may include a sensor hub capable of utilizing information collected by sensors 112 in determining the relative orientation and movement of IHS 100. For instance, the sensor hub may utilize inertial movement sensors, that may include accelerometer, gyroscope, and magnetometer sensors, and are capable of determining the orientation and movement of IHS 100 (e.g., IHS 100 is motionless on a relatively flat surface, IHS 100 is being moved irregularly and is likely in transport, the hinge of IHS 100 is oriented in a vertical direction thus indicating the IHS 100 is being used in a book mode). In certain embodiments, the sensor hub may also include capabilities for determining a location and movement of IHS 100 based on triangulation of network signal and based on network information provided by the OS or network interface 109. In some embodiments, the sensor hub may support additional sensors, such as optical, infrared and sonar sensors, that may provide support for xR (virtual, augmented, and/or mixed reality) sessions hosted by the IHS 100 and may be used by the sensor hub provide an indication of a user's presence near IHS 100, such as whether a user is present, absent, inattentive and/or facing integrated display 108.

In cases where the end-user is present before IHS 100, the sensor hub may further determine a distance of the end-user from the IHS, where this determination may be made continuously, at periodic intervals, or upon request. The detected or calculated distances may be used by processor 101 to classify the user as being in the IHS's near-field (user's position<threshold distance A), mid-field (threshold distance A<user's position<threshold distance B, where B>A), or far-field (user's position>threshold distance C, where C>B). As described in additional detail below, the failure to detect an authenticated user of IHS 100 within a proximity of IHS 100 may result in a change in the security context of IHS 100, thus triggering a re-evaluation of the security risk of workspaces operating on IHS 100. Similar re-evaluation may be triggered based on the detection of additional individuals in proximity to IHS 100.

In embodiments where IHS 100 may support multiple physical configurations, such as a convertible laptop, N-in-1 device, or the like, the sensor hub may utilize one or more mode sensors 112 that collect readings that may be used in determining the posture in which IHS 100 is physically configured. In certain embodiments, such posture determinations may be additionally made using the movement and orientation information provided by sensors 112. In laptop and convertible laptop embodiments, for example, processor 101 or trusted controller 115 may utilize a lid position sensor 112 to determine the relative angle between the two panels of the laptop in order to determine the mode in which IHS 100 is physically configured. In such embodiments, the lid position sensor may measure the angle of rotation of the hinge that connects the base panel and lid panel of IHS 100. In some embodiments, processor 101 or trusted controller 115 may provide collected lid position information, such as the hinge angle, to the sensor hub for use in determining the posture in which IHS 100 is configured. In some embodiments, the sensor hub may interface directly with the lid position sensor in determining hinge angle information.

The sensor hub may determine the posture of IHS 100 based, at least in part, on the angle of rotation of the hinge of IHS 100 from a closed position. Starting from a closed position, a first range of hinge angles may indicate a laptop posture, a second range of hinge angles may indicate a landscape posture, and a third range of hinge angles may indicate a tablet posture of the IHS 100. The sensor hub may additionally utilize orientation and movement information collected from inertial movement sensors 112 to further determine the posture in which IHS 100 is physically configured. For instance, if the sensor hub determines that IHS 100 is configured with a hinge angle of a laptop configuration, but IHS 100 is oriented on its side with the hinge in a vertical orientation, the IHS may be determined to be in a book mode. In another example where the IHS 100 is determined to be tilted such that the hinge is oriented between horizontal and vertical, the user's face is detected to be facing the integrated display, and IHS 100 is experiencing irregular, slight movements, the sensor hub may determine that IHS 100 is being used in a book posture while the user is in transit. In another example, the sensor hub may determine that IHS 100 is opened to a 180-degree hinge angle and lies on a flat surface, thus indicating that IHS 100 it is being used in a landscape posture. The sensor hub may similarly determine that IHS 100 is in a tent configuration in response to detecting a hinge angle within a defined range, such as between 300 and 345 degrees, and also detecting an orientation of IHS 100 where the hinge is aligned horizontally and is higher than both of the display panels of IHS 100.

Other components of IHS 100 may include one or more I/O ports 116 for communicating with peripheral external devices as well as various input and output devices. For instance, I/O 116 ports may include HDMI (High-Definition Multimedia Interface) ports for use in connecting external display devices 122G to IHS 100 and USB (Universal Serial Bus) ports, by which a variety of external devices may be coupled to IHS 100. In some embodiments, external devices coupled to IHS 100 via an I/O port 116 may include storage devices that support transfer of data to and from system memory 105 and/or storage devices 119 of IHS 100. As described in additional detail below, the coupling of storage devices via an I/O port 116 may result in a change in the security profile of IHS 100, thus triggering a re-evaluation of the security risk of workspaces operating on IHS 100. In some embodiments, peripherals coupled to IHS 100 via I/O ports 116 may be discrete devices with their own logic and memory resources that may be used in the operation of a workspace. In some scenarios, external peripherals coupled to IHS 100 may be a public or shared-use devices, such as a projector 122F utilized within a conference room.

Chipset 103 also provides processor(s) 101 with access to one or more storage devices 119. In various embodiments, storage device(s) 119 may be integral to IHS 100, or may be external to IHS 100. In certain embodiments, storage device(s) 119 may be accessed via a storage controller that may be an integrated component of the storage device. Storage device(s) 119 may be implemented using any memory technology allowing IHS 100 to store and retrieve data. For instance, storage device(s) 119 may be a magnetic hard disk storage drive or a solid-state storage drive. In some embodiments, storage device(s) 119 may be a system of storage devices, such as a cloud drive accessible via network interface 109. In some embodiments, storage devices 119 coupled to IHS 100 may be discrete devices with their own logic and memory resources that may be used in the operation of a workspace.

As illustrated, IHS 100 also includes BIOS (Basic Input/Output System) 117 that may be stored in a non-volatile memory accessible by chipset 103 via bus 102. Upon powering or restarting IHS 100, processor(s) 101 may utilize BIOS 117 instructions to initialize and test hardware components coupled to IHS 100. BIOS 117 instructions may also load an OS for use by IHS 100. BIOS 117 provides an abstraction layer that allows the OS to interface with the hardware components of IHS 100. The Unified Extensible Firmware Interface (UEFI) was designed as a successor to BIOS. As a result, many modern IHSs utilize UEFI in addition to or instead of a BIOS. As used herein, BIOS is intended to also encompass UEFI.

In certain embodiments, a trusted controller 115 is coupled to IHS 100 and may support various functions for management of IHS 100. For example, trusted controller 115 may be an embedded controller (EC) that is installed as a component of the motherboard of IHS 100. In various embodiments, trusted controller 115 may perform various operations in support of the delivery and deployment of a workspace to IHS 100. In certain embodiments, trusted controller 115 may interoperate with a remote orchestration service via an out-of-band communications pathway that is isolated from the OS that runs on IHS 100. Network interface 109 may support such out-of-band communications between trusted controller 115 and a remote orchestration service. In some embodiments, such out-of-band communications may be utilized by a remote orchestration service in communicating with the trusted controller 115 in selecting the resources of the IHS that are used as the underlying computing architecture that is used to host a workspace on the IHS 100.

Trusted controller 115 may receive cryptographic information required for secure delivery and deployment of a workspace to IHS 100. In such embodiments, the cryptographic information may be stored to secured storage 121 maintained by trusted controller 115. Additionally, or alternatively, trusted controller 115 may support execution of a trusted operating environment that may support cryptographic operations used to deploy a workspace on IHS 100. Additionally, or alternatively, trusted controller 115 may support deployment of a workspace within the OS of IHS 100 via an out-of-band communications channel that is isolated from the OS and allows the workspace to communicate with a trusted agent process of the OS.

Trusted controller 115 may also provide support for certain cryptographic processing used to support secure deployment and operation of workspaces on IHS 100. In some embodiments, such cryptographic processing may be provided via a secure logical environment that operates using computational and memory resources of trusted controller 115, where the environment operates in isolation from the software and other hardware components of IHS 100. In some embodiments, trusted controller 115 may rely on cryptographic processing provided by dedicated cryptographic hardware supported by the IHS, such as a TPM (Trusted Platform Module) microcontroller. In some embodiments, the memory resources of trusted controller 115 include a secured storage 121 that may be utilized to store cryptographic information for use in authorization of workspaces.

In certain embodiments, cryptographic capabilities of trusted controller 115 may be used to calculate signatures that uniquely identify individual components of IHS 100. In such scenarios, trusted controller 115 may calculate a hash value based on instructions used to configure a hardware component coupled to IHS 100 and/or based on a set of instructions used to operate a software program. For instance, trusted controller 115 may calculate a hash value based on firmware, settings and/or other instructions that are used in the operation of a hardware component coupled to the IHS 100, such as by a network controller, storage drive, storage controller, FPGA, or hardware accelerator. In some instances, reference signatures for individual components of an IHS 100 may be calculated as part of a trusted manufacturing and factory provisioning process of the IHS and may be stored for use as reference signatures within a secure storage 121 of the trusted controller 115.

Once the IHS 100 has been delivered and deployed, trusted controller 115 may be configured to calculate hash values based on firmware and other instructions that are loaded for use by individual hardware components of the IHS. The hash value recalculated for the component may then be compared against the reference signature in order to determine if any modifications have been made to the instructions to be used to operate the component, thus indicating the component has been compromised. In this manner, trusted controller 115 may be used to validate the integrity of hardware and software components installed on IHS 100. In certain embodiments, remote orchestration service 206 may verify the integrity of trusted controller 115 in the same manner, by calculating a signature based on instructions being utilized to operate trusted controller 115 and comparing it to a reference signature calculated during a trusted process for manufacture of IHS 100. In various embodiments, one or more of these operations supported by trusted controller 115 may be implemented using BIOS 117.

In some embodiments, firmware instructions utilized by trusted controller 115 may also implement procedures for the management of power that is available for operating IHS 100. For instance, trusted controller 115 may interface with a power adapter in managing the output levels of the power adapter that may be drawn for use by IHS 100. In some embodiments, trusted controller may determine the power status of IHS 100, such as whether IHS 100 is operating strictly from battery power or is plugged into an AC power source, and may specify restrictions on power use based on the power status of the IHS. Trusted controller 115 may be used to operate a secure execution environment that may include operations for managing various core functions of IHS 100 based on power availability, such as power management and management of certain operating modes of IHS 100 (e.g., turbo modes, maximum operating clock frequencies of certain components, etc.). Accordingly, IHS 100 may support the use of various power modes. In some embodiments, the power modes of IHS 100 may be implemented through operations of trusted controller 115 and/or the OS of IHS 100. In various embodiments, IHS 100 may support various reduced power modes in order to reduce power consumption and/or conserve battery power when IHS 100 is not actively in use, and/or to control a level of performance available to the user by increasing or decreasing a maximum operating clock frequency of a component of IHS 100 (e.g., processor(s) 101).

In managing operating modes of IHS 100, trusted controller 115 may implement operations for detecting certain changes to the physical configuration of IHS 100 and managing the modes corresponding to different physical configurations of IHS 100. For instance, where IHS 100 is a laptop computer or a convertible laptop computer, trusted controller 115 may receive inputs from a lid position sensor 112 that may detect whether the two sides of the laptop have been latched together to a closed position. In response to lid position sensor 112 detecting latching of the lid of IHS 100, trusted controller 115 may initiate operations for shutting down IHS 100 or placing IHS 100 in a low-power mode.

As described in additional detail below, an IHS 100 may support the operation of one or more workspaces, each operating using resources of IHS 100 that are specified within a respective workspace definition, where an individual workspace provides operation of software programs and access to protected data in varying degrees of isolation from the operating system of the IHS and from other workspaces. Also as described in additional detail below, an individual workspace may be hosted by an IHS 100 using various combinations of the described software and hardware resources of the IHS. For instance, a workspace may be configured to operate as a type of virtual machine that runs in isolation from the operating system of the IHS 100, but that relies on certain shared software libraries and other resource of the IHS 100. In another instance, a workspace may operate as a different type of virtual machine that not only runs in isolation from the operating system of the IHS 100, but also does not share any libraries and operates using a segregated portion of memory 105 of the IHS. In another instance, a workspace may operate as a container application that runs within the operating system of the IHS 100, but that provides a segregated computing environment in which applications and data that are accessed via the container are not otherwise accessible by other programs or containers hosted by the operating system. In another instance, a workspace may operate within the operating system of an IHS 100 as a web-browser application that runs using libraries and other resources utilized by the web browser. In another instance, a workspace may be configured to operate such that a graphical interface for the workspace is displayed in a display device 108, 122G of the IHS 100, but the workspace operates in full or in part in a cloud resource, thus isolating certain aspects of the workspace entirely from the IHS 100.

Each of these exemplary computing architectures that utilize resources of IHS 100, to support workspaces present different attack surfaces that may be exploited by malicious actors. As described in additional detail below, the computing architecture that is selected for use by a workspace may be selected based in part on a security context that may account for the security posture of the IHS 100, the user of the IHS 100, the use of subordinate workspaces, the environment in which IHS 100 is being operated and/or the information that is being accessed via the workspace. As such, the attack surface presented by the computing architecture of a workspace, and any subordinate workspaces, may be selected to be commensurate with the security context in which the workspace will operate. Further, embodiments of the present systems and methods for distributing workloads across devices based on network conditions may be employed to secure these workspaces.

In some embodiments, an IHS 100 may not include all of the components shown in FIG. 1. In other embodiments, an IHS 100 may include other components in addition to those that are shown in FIG. 1. Furthermore, some components that are represented as separate components in FIG. 1 may instead be integrated with other components. For example, in certain embodiments, all or a portion of the operations executed by the illustrated components may instead be provided by components integrated into processor(s) 101 as a System-on-Chip.

In some embodiments, the construction of a workspace for a particular purpose and for use in a particular context may be orchestrated remotely from IHS 100 by workspace orchestration services 206, such as described with regard to FIGS. 2A and 2B. In some embodiments, portions of the workspace orchestration, including the creation and delegation of tasks to subordinate workspaces, may be performed locally on IHS 100. IHS 100 may be configured with program instructions that, upon execution, cause IHS 100 to perform one or more of the various operations disclosed herein. In some embodiments, IHS 100 may be an element of a larger enterprise system that may include any number of similarly configured IHSs in network communications with each other.

FIGS. 2A and 2B are, together, a diagram (collectively referred to as FIG. 2) depicting a method, according to various embodiments, for orchestrating the deployment and operation of workspaces on an IHS, such as IHS 100. For sake of illustration, method 200 has been split into three phases: workspace initialization phase 200A, workspace orchestration phase 200B, and workspace termination phase 200C. During initialization 200A, user 201 (e.g., an enterprise user) operates an IHS 100 (e.g., a desktop, a laptop, a tablet, a smart phone, etc.), such as described with regard to FIG. 1, within physical environment 202 (e.g., any type of environment and its associated context, including physical location, geographic location, location within a particular facility or building, detected wireless networks, time of day, proximity of the user to IHS 100, other individuals in the vicinity of IHS 100, etc.).

Method 200 may begin with the user 201 selecting workspace options that are supported by launch point 203 that may be, for example, a corporate launch point provided by an employer of user 201, a launch point provided by the manufacturer of IHS 100, a launch point provided in support of a software application operating on IHS 100, or a launch point provided as a service to user 201 by a third-party. In some implementations, user 201 may operate IHS 100 to access launch point 203 provided, for example, in the form of a web portal, a portal application running in the OS of IHS 100, a special-purpose portal workspace operating on IHS 100, or the like. In various implementations, launch point 203 may include Graphical User Interface (GUI) elements representing different software applications, data sources and/or other resources that the user may desire to execute and/or manipulate within a workspace. In various embodiments, launch point may provide a graphical, textual and/or audio interface by which data or other resources may be requested for use within a workspace by a user 201. In this manner, a user 201 may be provided with launch point 203 selections that provide access to one or more software applications and an aggregation of user's data sources that are available across one or more datastores (e.g., local storage, cloud storage, etc.).

As described in additional detail below, workspaces for providing user 201 with access to requested data or other resources may operate using a local management agent 332 that operates on IHS 100 and is configured to interoperate with a workspace orchestration service that may include one or more remote workspace orchestrators 206A-N. In various embodiments, launch point 203 may be provided in the form of a portal (e.g., a webpage, OS application or special purpose workspace) that allows user 201 to request access to managed resources. In various embodiments, launch point 203 may be hosted by a remote workspace orchestrator 206A-N, local management agent 332 operating on IHS 100, or any suitable combination thereof. Examples of launch point 203 technologies may include WORKSPACE ONE INTELLIGENT HUB from WMWARE, INC., and DELL HYBRID CLIENT from DELL TECHNOLOGIES INC., among others.

The initialization phase 200A of a workspace may begin when user 201 chooses to launch an application or access a data source managed by a workspace orchestration service that may be implemented using one or more workspace orchestrators 206A-N. In response to an access request issued by user 201 (e.g., the user “clicks” on an icon of launch point 203), local management agent 332 of IHS 100 collects initial security and productivity context information at 204. For example, security context information may include attributes indicating a security risk associated with: the data and/or application being requested, a level of risk presented by the user 201, the hardware utilized by IHS 100, the logical environment of IHS 100 in which a workspace will be deployed to provide access to the requested data and/or application, characteristics of external devices 122A-H that are coupled to IHS 100, and the physical environment 202 in which IHS 100 is currently located.

Accordingly, in this disclosure, the term “security context” generally refers to data or other information related to a security posture in which a workspace will be deployed and utilized, where the security posture may be based on the user, IHS 100, security characteristics of external devices 122A-H coupled to IHS 100, data to be accessed via the workspace, and/or environment 202. A security context may be quantified as a security risk score in support of evaluations of the level or risk associated with providing user 201 access to requested data and/or application while using IHS 100 in the particular context. A “security risk score” generally refers to a numerical value usable to score, quantify, or measure various security characteristics of the security context associated with a request. A risk score may be an aggregate score associated with the overall security risk context, whereas a “risk metric” may be a measurement of risk for a sub-category of some part of the security context.

For example, security metrics that may be used in the calculation of a security risk score for a particular security context may include, but are not limited to: a classification of the requested data source and/or application, authentication factors used to identify user 201, the location of IHS 100, a role or other group classifications associated with user 201, validation of networks in use by IHS 100, type of network in use by IHS 100, network firewall configurations in use by IHS 100, indicators of attack (IoA), indicators of compromise (IoC) regarding IHS 100 or a resource being requested by user 201, patch levels associated with the OS and other applications in use on IHS 100, availability of encryption, type of available encryption, access to secured storage, use of attestable hardware by IHS 100, supported degree of workspace isolation by IHS 100, external devices 122A-H that are coupled to IHS 100, etc. Further, embodiments of the present systems and methods for distributing workloads across devices based on network conditions may be employed to secure these workspaces.

The term “productivity context” generally refers to user productivity associated with a workspace, user, IHS, and/or environment. A “productivity score” generally refers to an index usable to score, quantify, or measure various productivity characteristics of a productivity context. Examples of productivity context information include, but are not limited to: the hardware of the IHS, the software of the IHS (e.g., the OS), power states and maximum clock frequencies of selected components of the IHS, peripheral devices 122A-H coupled to the IHS, either permanently or temporarily, networks available to the IHS and the performance characteristics of those networks, software installers available on the IHS, etc.

Initial productivity and security targets for instantiation of a workspace may be calculated based on the context of user's 201 actions in requesting the workspace (e.g., procedures used to identify the user) combined with the productivity and security context in which the workspace will operate. The productivity and security targets may also be based on behavioral analytics related to user 201, IHS 100 telemetry and/or environmental information (e.g., collected via sensors 112). In some cases, at 205, a local management agent operating on IHS 100 may calculate initial security and productivity targets based upon the collected security and productivity context. In other cases, a remote workspace orchestrator 206A-N may calculate security and productivity targets for instantiation of a workspace on IHS 100.

As used herein, the term “security target” generally refers to the attack surface presented by a workspace that is created and operated based on a workspace definition, while the term “productivity target” generally refers to the productivity characteristics of a particular workspace definition. Examples of a productivity target include, but are not limited to: type of data or data source available to user 201, minimum latency of a workspace, responsiveness of the IHS 100, etc. Attributes that may be used to characterize a security target may include, but are not limited to: a minimum security score for a workspace, a minimum trust score of IHS 100, authentication requirements for user 201 (e.g., how many authentication factors are required, frequency of re-authentication), minimum level of trust in the network utilized by a workspace, required isolation of a workspace from other processes operating on IHS 100, the ability to access a browser within a workspace, the ability to transfer data between workspaces, the ability to extend a workspace, etc. Further, embodiments of the present systems and methods for distributing workloads across devices based on network conditions may be employed to meet such security targets.

Moreover, the term “workspace definition” generally refers to a collection of attributes that describe aspects a workspace that may be assembled, created, and deployed in a manner that satisfies a security target (i.e., the definition provides an attack surface for the workspace that presents an acceptable level of risk) and a productivity target (e.g., data access, access requirements, upper limits on latency, etc.) in light of the security context (e.g., location, patch level, threat information, network connectivity, etc.) and the productivity context (e.g., available computing resources on IHS 100, performance characteristics of IHS 100, network speed, etc.) in which the workspace is to be deployed. A workspace definition may enable fluidity of migration of an instantiated workspace, since the definition supports the ability for a workspace to be assembled on any IHS according to embodiments that is configured for operation with a workspace orchestration service.

In describing capabilities and constraints of a workspace, a workspace definition 208 may prescribe one or more of: authentication requirements for user 201, containment and/or isolation of the workspace (e.g., local application, sandbox, docker container, progressive web application or “PWA,” Virtual Desktop Infrastructure “VDI,” etc.), primary applications that can be executed in the defined containment of the workspace to enable user 201 to be productive with one or more data sources, additional applications that are included in the workspace to enhance productivity, security components that reduce the scope of the security target presented by the productivity environment (DELL DATA GUARDIAN from DELL TECHNOLOGIES INC., an anti-virus, etc.), the data sources to be accessed and requirements for routing that data to and from the workspace containment (e.g., use of VPN, minimum encryption strength), workspace capabilities to independently attach other resources, constraints on the ability to generate subordinate workspaces, descriptions of any already operating subordinate workspaces, etc.

In some embodiments, the workspace definition 208 selected for operation of a workspace may specify a computing architecture for use in the operation of the workspace. Such a computing architecture may be selected for use by a workspace based in part on a security context of the IHS, where this security context may account for factors such as the security posture of the IHS 100, the user 201 of the IHS 100, the environment 202 in which IHS 100 is being operated and/or the information that is being accessed via the workspace. In this manner, the attack surface presented by the computing architecture in use by a workspace may be selected to be commensurate with the security context in which the workspace will operate.

In some implementations, workspace definitions may be based at least in part on static policies or rules defined, for example, by an enterprise's Information Technology (IT) Decision Maker (ITDM). In accordance with embodiments of the present systems and methods, for workspace instantiation using continuous vulnerability intelligence feedback, a workspace orchestrator may operate as an ITDM, or the ITDM may operate as a workspace orchestrator. ITDM service(s) may be provided on premises, along with one or more of managed IHSs, or may be remotely located with respect to managed IHSs. For example, one or more of managed IHSs may be deployed remotely with respect to an enterprise, business, or corporation having an ITDM in charge of managing the usage, operation, servicing, configuration, and other aspects of the IHSs. Particularly, an ITDM may use one or more management tools, such as, WINDOWS Admin Center, MICROSOFT Endpoint Configuration Manager, System Center Configuration Manager (SCCM), AZURE, INTUNE, VMWARE WORKSPACE ONE, etc. In some implementations, static rules may be combined and improved upon by machine learning (ML) and/or artificial intelligence (AI) algorithms that evaluate historical productivity and security data collected as workspaces are life cycled. In this manner, rules may be dynamically modified over time to generate improved workspace definitions. If it is determined, for instance, that a user dynamically adds a text editor every time he uses MICROSOFT VISUAL STUDIO from MICROSOFT CORPORATION, then workspace orchestration service 206A-N may autonomously add that application to the default workspace definition for that user.

Still with respect to FIG. 2, during orchestration 200B, the initial security and productivity targets are processed and/or reconciled against resources, device capabilities, and cloud services available, etc., to produce a workspace definition at 208. As described, a workspace definition may specify capabilities and constraints of a workspace, such as: runtime security requirements of the workspace containment (e.g., such as isolation from the OS of IHS 100 or from certain hardware of IHS 100), the use of reference measurements to attest to the integrity of the workspace once running, applications to be provided for operation within the workspace, aggregation of resources available via the workspace, access configurations (e.g., virtual private network or “VPN”), etc. Further, embodiments of the present systems and methods for distributing workloads across devices based on network conditions may be employed to meet such runtime security requirements.

The initial workspace definition may then be utilized by automation engine of workspace orchestration service 206 to coordinate assembly 209 and instantiation 210 of a workspace using a selected computing architecture of the IHS 100 in which the workspace will operate. In cases where a workspace is cloud-hosted, automation engine may assemble and instantiate a remote workspace that may be accessed via a secure connection established via a web browser or other web-based component operating on IHS 100. In some embodiments, automation engine may resolve configuration conflicts between a workspace definition and the user's inputs in the operation of a workspace.

The instantiated workspace is operated by user 201 at 211, and new productivity and security context information related to the behavior or use of data is generated at 212. This operation of a workspace may result in a change or new classification of data based upon what user 201 has done, accessed, and/or created, thus resulting in a change to the security context of the workspace. To the extent the user's behavioral analytics, device telemetry, and/or the environment has changed to a quantifiable degree, these changes in security context may serve as additional input for a re-evaluation of the security and performance targets at 207 by automation engine. Additionally, or alternatively, new workspace context, security target, and/or productivity target may be now measured against the initial targets, and the result may cause automation engine to produce a new workspace definition at 208, if appropriate, such as, in accordance with embodiments of the present systems and methods, for workspace instantiation using continuous vulnerability intelligence feedback.

Particularly, if the productivity score and/or the security score for an instantiated workspace change such that a score is outside of the range of the respective target index, automation engine may determine appropriate modifications to an existing workspace and deploy such modifications at 210. In instances where the difference between one or both of the productivity and security score and a respective index is a below a threshold value, the automation engine may generate an updated workspace definition that adapts the existing workspace for operation in the updated security and/or productivity context, for example, in accordance with embodiments of the present systems and methods, for workspace instantiation using continuous vulnerability intelligence feedback. In instances where the difference between the productivity and security score and a respective index is a above a threshold value, the automation engine may elect to terminate 213 the existing workspace and to generate a new workspace definition for a new workspace 210 that is configured for operation in the updated security and/or productivity context. In generating a new workspace 210, session data metadata and context may be preserved by a data aggregation engine and session data may be restored within the new workspace as applicable.

Additionally, or alternatively, method 200 may terminate or retire the initial or previous workspace at 213, as part of termination phase 200C. In some cases, user action may initiate the termination process (e.g., user 201 closes application or browser accessing data) and/or termination may take place automatically as part of an adjustment in workspace definition (e.g., the isolated environment is instructed to terminate by automation engine 302). Also, as discussed in detail below, adjustment of the security score, and thus the security context, may result in termination of the workspace. Still, as part of termination phase 200C, workspace resources of IHS 100 and/or at workspace orchestration service 206 may be released.

As indicated in FIG. 2, method 200 may include the use of multiple remote workspace orchestrators 206A-N that participate in the launching and operation of a workspace on an IHS 100. In various embodiments, any number of remote workspace orchestrators 206A-N may participate in the ongoing operation of a workspace. For instance, remote workspace orchestrator 206A may be operated by the manufacturer of IHS 100 and may support configuration of a workspace on IHS 100 that provides the user with a launch point for requesting access to protected resources. Through this launch point, a user may select access to protected corporate data, such as a spreadsheet that includes protected corporate financial information. Based on this selection, a local management agent operating on IHS 100 may invoke a corporate remote workspace orchestrator 206B that provides a workspace definition for use in configurating and operating a new workspace on IHS 100 that provides protected access to the requested spreadsheet. In one scenario, safely accessing the requested spreadsheet may require installation of an updated spreadsheet program on IHS 100. In this scenario, the local management agent of the IHS 100 may invoke a third remote workspace orchestrator 206N for initiating an update to the spreadsheet program that is available through the workspace. In this manner, various remote workspace orchestrators 206A-N may support the deployment and ongoing operation of workspaces on an IHS 100.

As such, in various embodiments, method 200 enables secure user productivity even when a workspace operates on an IHS or cloud platform that is not under direct management. Method 200 also provides for dynamic or adaptive configurations and policies allowing for the best possible user experience while maintaining appropriate level of security. In some cases, the definition of a productivity environment and access requirements may be selected based upon productivity and security dependencies and targets, and the definition of capabilities related to the workspace may be adaptive in nature. Particularly, workspace definition attributes may be dynamically selected based upon historical productivity and security information, based upon each individual user or group's behavior.

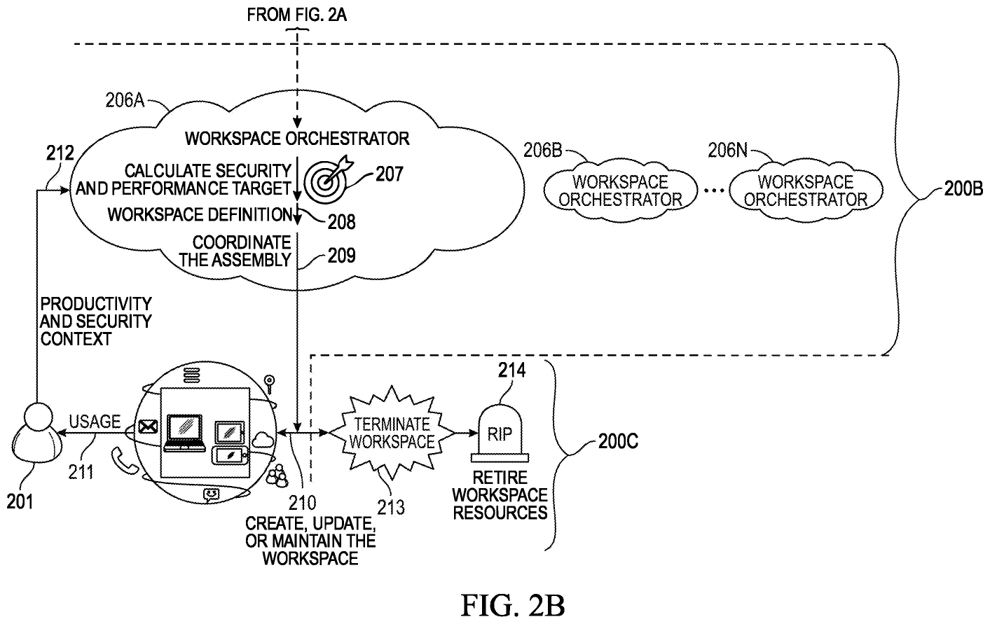

FIG. 3 is a diagram depicting an end-user workspace view 350 with list of workloads running on an end-user laptop and a list of workloads running on an end-user mobile device, according to some embodiments. Regarding the end-user workspace view 350, test1 360, for example, depicts a cloud-based workload (e.g., WebApps), while test 370, for example, depicts a Virtual Desktop Infrastructure (VDI) based workload (e.g., Citrix/VMWare Virtual Desktops). Since some embodiments of the present disclosure provide for workload level transitioning or migration, this figure highlights the segregation of workloads provided at the end-user level. This segregation of workloads is further depicted by the laptop with authorized applications 310 hosting application1 312 and application 2 314, while the mobile device with authorized applications 330 hosts its own application1 332 and application 2 334.

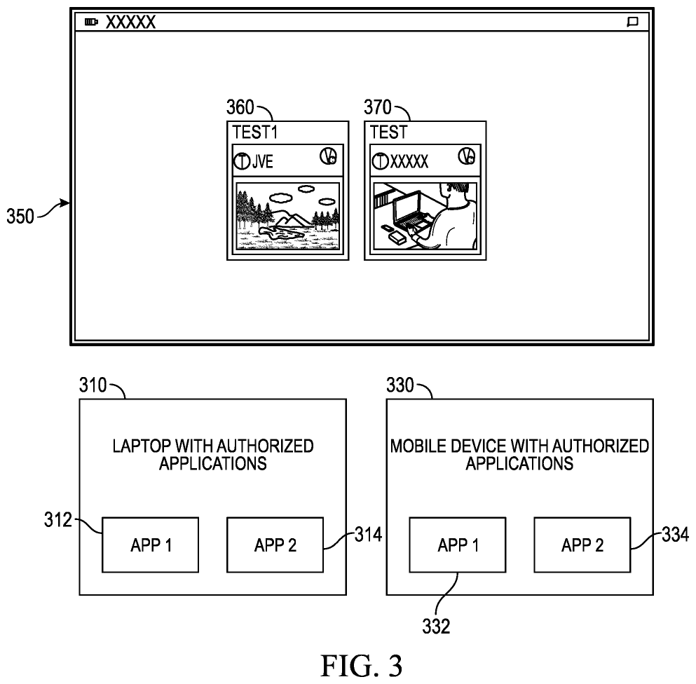

FIG. 4 is a diagram depicting a cloud management 450 orchestrating workloads (415, 435) across multiple IHSs (410, 430) of a single user (490), according to some embodiments. FIG. 4 depicts the multiple IHSs to be a laptop 410, for example, and a mobile device 430, as another example. A workspace can, in some embodiments, be an isolated environment that can host one or more applications (e.g., Web Apps, native applications, etc.). A workspace can be planned and deployed by an Information Technology Decision Maker (ITDM), for example. In some embodiments, the workspace can be software based (e.g., like docker) or hypervisor based (e.g., like Kata container or VM) solutions to provide an isolated environment. The mobile IHS devices 430 can include Smart phones and/or tablets, in some embodiments.

Some embodiments of the system and methods for distributing workloads across devices based on network conditions provide for orchestration and optimization of IHSs, and composition for agnostic user interfaces, while preserving key parts of a traditional client experience. A workspace can, in some embodiments, either run as cloud-native (“cloud”) or endpoint-native (“endpoint”). The concept requires the IHS to have workload orchestration with concurrent workspaces of varying performance and security parameters running on the endpoint as well as in the cloud. The workspaces can be implemented using container technologies, in some embodiments.

Some embodiments of the systems and methods for distributing workloads across devices based on network conditions provide for user mobility across IHS devices (including, for example, laptops, desktops, and mobile devices like smart phone and tablets, etc.). IHS devices that need to be supported will vary with respect to many factors, including but not limited to: operating system, form factors, supported peripherals, network connectivity (Wired/Wireless), hardware resources (like memory, CPU etc.), network capabilities, etc.

For an enhanced workspace experience by end users, the systems and methods for distributing workloads across devices based on network conditions can, in some embodiments, ensure that all the supported host IHS devices are utilized optimally based on IHS capabilities and available resources including network capabilities. A workspace orchestrator, such as a cloud management 450, can obtain specifications of the host IHSs, and can obtain network connectivity parameters of some or all of the IHSs. Specifications may include the device's capabilities, expressed as it's hardware characteristics, resources, application provenance, workloads, and the like, such as operating system, form factors, supported peripherals, hardware resources (like memory, CPU etc.), UEFI Secure Boot capabilities, monitor privacy filter, protected private regions of memory, IHS OS, a security sandbox, role-based access control, data regarding workloads hosted by the IHS and/or the like.

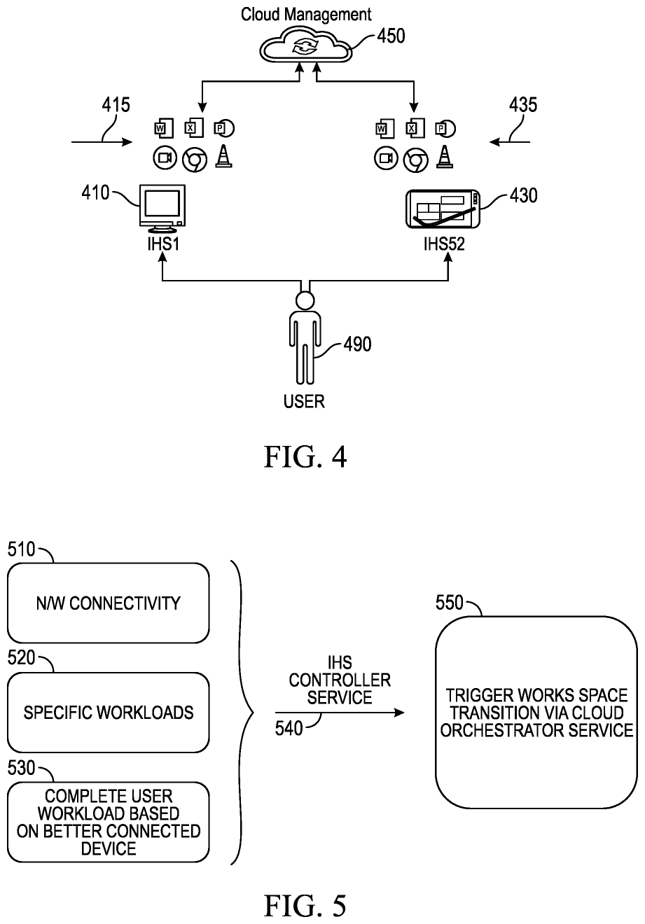

FIG. 5 is a diagram generally depicting various parameters (510, 520, 530) used by an agent service (e.g. an IHS controller service 540) to trigger a workspace transition 550 via a cloud orchestrator service, according to some embodiments. The various parameters can be network connectivity 510, the condition of specific workloads 520, or a complete user workload based on a better-connected device 530. Network connectivity parameters can include network connection status, network connection type (e.g., wired/wireless), network connection speed, network latency in receiving responses, and/or the frequency of network connection drops, etc. In some embodiments, an agent service (e.g., an IHS controller service 540) running on a device will report the parameters to a management console orchestrator service. The orchestrator service can trigger a selective workload transition of some or all of the workloads to another IHS.

Context can be provided for FIG. 5 by 3 example use cases. A first use case provides for a complete session switch based on better network connectivity (e.g., a connected status, higher speed, lower latency, fewer connection drops, etc.). In this first use case, an end user is in office and is on a Zoom call and working on his notebook (IHS-1) with wireless network connectivity of 100 Mbps. He is also running MIRO and several other modern apps in the background. Also, he is working on a network intensive productivity app. The end user has another Desktop device (IHS-2) having wired network connectivity of 1 Gbps. Suddenly connection drops and higher latency is detected on IHS-1, and it's detected that the zoom call is getting dropped and reconnected frequently. Also, he is unable to work on network intensive productivity app due to lag. In this case, an agent service (e.g., an IHS controller service 540) running on both the devices will report the parameters to a management console orchestrator service. This service will trigger the complete transition of session from IHS-1 to IHS-2.

A second use case provides for selective switching of specific workloads (e.g., Teams, Zoom call etc.). In this second use case, an end user is in his home and is on a Zoom call and working on his notebook (IHS-1) with wireless network connectivity of 100 Mbps. He is also running MIRO and several other modern apps in the background. Also, he is working on developing a new feature using Visual Studio Code for the Web. The end user has another mobile device having 5G network connectivity provided by a mobile network operator (IHS-2). Suddenly connection drops are detected on IHS-1, and it's detected that zoom call is getting dropped and reconnected frequently. Also, he is unable to work on a network intensive productivity app due to lag. In this case, an agent service (e.g., an IHS controller service 540) running on both the devices will report the parameters to a management console orchestrator service. The service will trigger a selective workload transition of Zoom call to IHS-2, and the end user can continue working on other workloads in IHS-1.

A third use case provides for selective switching to better connected device based on current user workload. In this use case, an end user is in his home and working on his notebook (IHS-1) with wireless network connectivity of 100 Mbps. He is running MIRO and several other modern apps in the background. Also, he is working on developing a new feature using Visual Studio Code for the Web. The end user has another mobile device having 5G network connectivity provided by a mobile network operator (IHS-2). Suddenly connection drops and higher latency is detected on IHS-1, and it's detected that zoom call is getting dropped and reconnected frequently. Also, he is unable to work on a network intensive productivity app due to lag. In this case, an agent service (e.g., an IHS controller service 540) running on both the devices will report the parameters to a management console orchestrator service. The service can trigger a selective workload transition of the Zoom call and productivity apps to IHS-2. Since it will be difficult to work on Visual Studio Code for the Web on IHS-2, the end user will get notified of the same, and can continue working on Visual Studio Code on IHS-1.

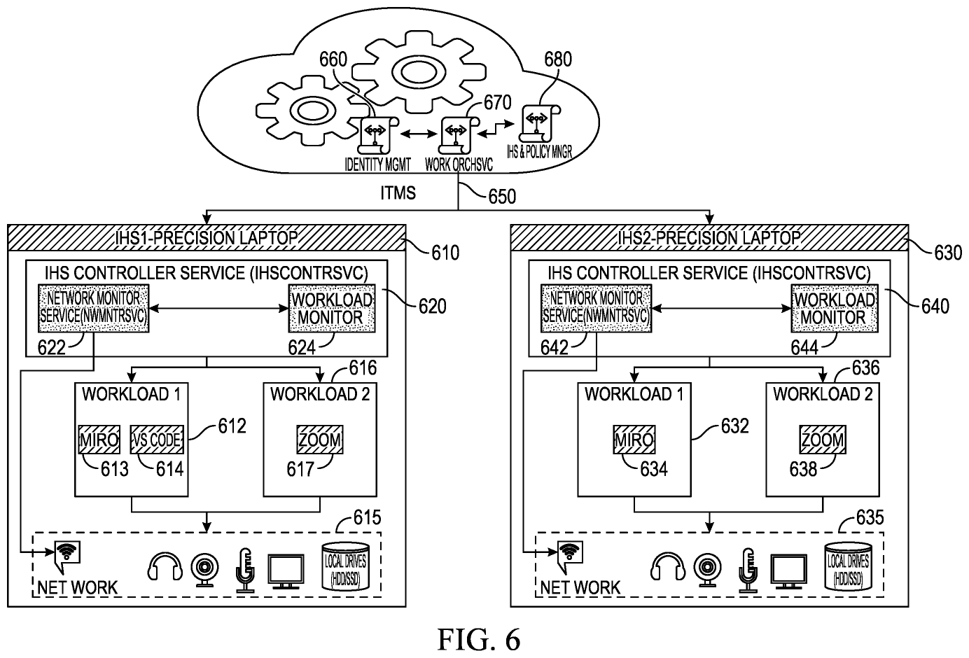

FIG. 6 is a system architecture block diagram generally depicting two client IHSs (610, 630) whose workloads (612, 616, 632, 634) are orchestrated by a workspace orchestration service 670 of an information technology management system (ITMS) 650, according to some embodiments. The workloads can consist of applications such as MIRO (613, 614), Visual Studio Code (614), and Zoom (617, 638). To assist in orchestrating and transitioning workloads, the workspace orchestration service 670 can receive information from an identity management service 660 and/or an IHS & policy manager component 680. Some embodiments of the systems and methods for distributing workloads across devices based on network conditions can comprise the following major components:
(1) A network and/or workload monitoring service (NWMntrSvc) running on the IHS devices. For example, network monitor service (622, 642) and workload monitor (624, 644). These service(s) can be responsible for actively monitoring network parameters like bandwidth, latency, connection drops, etc., as well as user's workloads which can be actively and extensively dependent on network connectivity.
(2) A workspace orchestrator service (WorkOrchSvc) (670) to communicate with IHS controller service (620, 640) running on every IHS device (610, 630). This workspace orchestrator service can be responsible for transitioning and/or distributing the workload from one IHS to another.
(3) An IHS controller service (IHSContrSvc) (620, 640). This service can be working as communication medium between the NWMntrSvc (622, 642) and WorkOrchSvc 670. It can also actively facilitate the transition of workloads on IHS devices

The above-mentioned components can work together to transition specific or complete workloads from one IHS device to other based on certain parameters. There can be multiple parameters which can initiate workload transition, in some embodiments. Some of them but not all are listed in FIG. 5. A use case can explain how this transition can be done from one IHS device to another. For selective switching to better connected device based on current user workload a use case can be as follows:

On a notebook (IHS-1) (610) an end user is running MIRO 613 and several other modern apps in the background. Also, he is working on developing a new feature using Visual Studio Code 614. Suddenly connection drops and higher latency is detected on IHS-1 by NWMntrSvc, and it's detected that a Zoom call 617 is getting dropped and reconnected frequently. Also, the he is unable to work on the network intensive productivity app (e.g. MIRO) due to lag.

The end user has another mobile device having 5G network connectivity provided by mobile network operator (IHS-2) (630). The NWMntrSvc service 622 of IHS-1 610 will trigger a selective workload transition of the Zoom call 617 and productivity apps 613 to IHS-2 630 via IHSContrSvc 620 and WorkOrchSvc 670. The transitioned workloads are MIRO 634 and Zoom 638 on IHS-2 630. Since it will be difficult to work on Visual Studio Code 614 on IHS-2, the end user will get notified of the same by WorkOrchSvc 670 and can continue working on VS Code once the connection improves on IHS-1. Some embodiments can also ensure there are no additional overhead on workload switch.

When all the apps being used are available on both IHS devices, there is no issue in migrating complete and/or specific workloads (e.g., Zoom, Teams available on the IHS devices). Therefore, some embodiments ensure seamless transfer of the complete workspace to the other IHS with better network connectivity. When selective apps (such as VS code 614) are not present on the second IHS, however, instead of transferring the workload and creating overhead, some embodiments can transfer applications that are present in the 2^{nd} IHS device.

As an additional embodiment, when there is a mismatch in apps availability on the IHS devices, WorkOrchSvc 670 can make sure to use compatible apps (e.g., Web app version of the apps) when migrating and loading apps on the other device (e.g., Zoom 617 on a laptop 610 to a Webapp version of Zoom 638 the mobile device 630, since it is not locally installed on the mobile device). Additionally, the WorkOrchSvc 670 can regularly monitor the IHS devices for app compatibility issues and/or resource availability to run the apps. When migrating the complete and/or specific workloads, it can consider the overheads, and accordingly transfer the workloads.

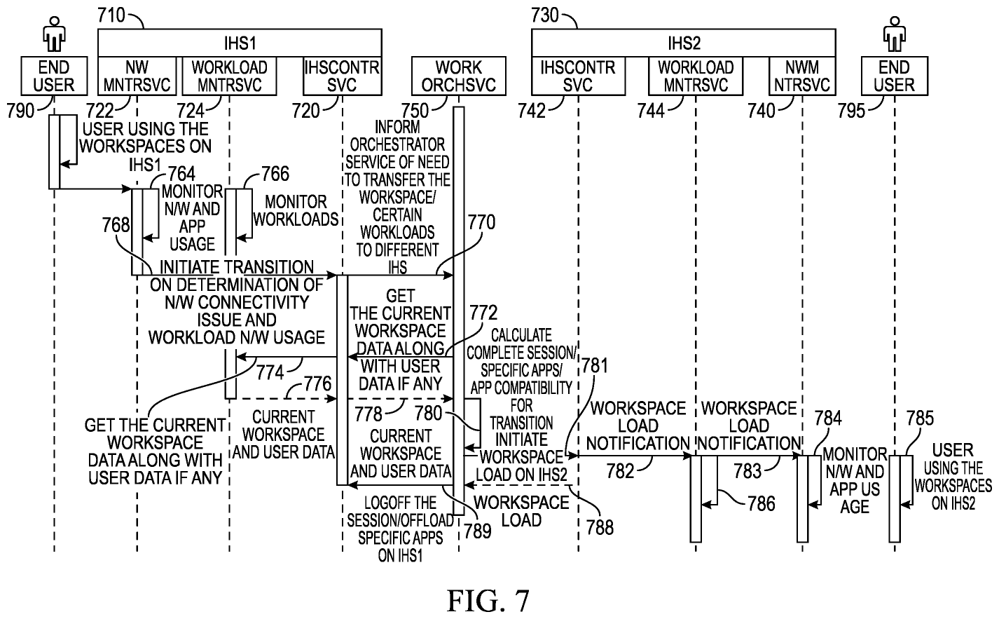

FIG. 7 is an operational flowchart diagram depicting a more detailed implementation of distributing workloads from IHS-1 to IHS-2 based on network conditions, according to some embodiments. FIG. 7 begins an end user 790 using the workspaces on IHS-1 710. The network monitoring service 722 of IHS-1 710 monitors network and application usage 764. The workload monitoring service 724 of IHS-1 monitors workloads 766. The network monitoring service 722 can initiate a transition 768 to the IHS controller service 720 based on a determination of network connectivity issues and/or workload network usage. The IHS controller service 720 can inform 770 the workspace orchestrator service 750 of a need to transfer the workspace and/or certain workloads to a different IHS.

Based on this informing 770, the workspace orchestrator service 750 can get 772 the current workspace data along with user data, if any from the IHS controller service 720. The IHS controller service 720 can, in turn, get 774 the current workspace data along with user data, if any, from the workload monitoring service 724. The workload monitoring service 724 can provide 776 the current workspace and user data to the IHS controller service 720. The IHS controller service 720 can provide 778 the current workspace and user data to the workspace orchestrator service 750.

The workspace orchestrator service 750 can then calculate 780 a complete session or specific apps for application compatibility for the transition. The workspace orchestrator service 750 can then initiate 781 a workspace load on IHS-2 730 through a communication with the IHS controller service 742 of IHS-2 730. The IHS controller service 742 can provide a workspace load notification (782, 783) to the workload monitoring service 744 and the network monitoring service 740 of IHS-2 730. The workload monitoring service 744 can then monitor workloads 786, and the network monitoring service 740 can monitor network and application usage 784 on IHS-2 730. The end user 795 can then use 785 the workspaces on IHS-2 730.

Finally, the IHS controller service 742 of IHS-2 can provide a workspace loaded notification 788 to the workspace orchestrator service 750. The workspace orchestrator service 750 can then provide a notification to the IHS controller service 720 of IHS-1 710 to logoff the session and/or offload specific application on IHS-1 (789).

In accordance with the foregoing, embodiments of the present systems and methods employ intelligent actions derived on availability of platform security characteristics, workload threat analysis, and vulnerability profiling to provide distributing workloads across devices based on network conditions. Embodiments of the present systems and methods also attribute control definitions that dynamically transform how data is used through context and intent to provide the distributing of workloads across devices based on network conditions.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,”“has,”“includes” or “contains” one or more elements possesses those one or more elements but is not limited to possessing only those one or more elements. Similarly, a method or process that “comprises,”“has,”“includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS) of a workspace orchestration service comprising:
a processor; and
a memory coupled to the processor, the memory having program instructions stored thereon that, upon execution, cause the processor to:
obtain, from a plurality of host IHSs, a respective plurality of specifications of the respective plurality of host IHSs, wherein a first host IHSs of the plurality of host IHSs hosts a plurality of workloads;
obtain, from one or more of the plurality of host IHSs including a second host IHS of the plurality of host IHSs, a respective one or more network connectivity parameters of the one or more host IHSs, including at least one network connectivity parameter from the second host IHS; and
transition one or more of the plurality of workloads from the first host IHS to the second host IHS based, at least in part, on the specifications of the first and second host IHSs, and the at least one network connectivity parameter of the second host IHS.

2. The IHS of claim 1, wherein the network connectivity parameters comprise at least one of: network connection status, network connection type, network connection speed, network latency in receiving responses, or a frequency of network connection drops.

3. The IHS of claim 1, wherein the specifications comprise at least one of: hardware characteristics, application provenance, IHS operating system, form factors, supported peripherals, hardware resources, UEFI Secure Boot capabilities, monitor privacy filter characteristics, protected private regions of memory, security sandbox information, role-based access control information, or data regarding workloads hosted by the IHS.

4. The IHS of claim 2, wherein the plurality of workloads hosted by the first host IHS comprise a workspace of the first host IHS, and wherein the workspace of the first host IHS is planned and deployed by an Information Technology Decision Maker (ITDM).

5. The IHS of claim 1, wherein to obtain, from the one or more host IHSs the respective one or more network connectivity parameters of the one or more host IHSs, the program instructions further cause the processor to:
obtain, from the first host IHS, at least one network connectivity parameter of the first host IHS; and
wherein to transition the one or more of the plurality of workloads from the first host IHS to the second host IHS, the program instructions further cause the processor to:
determine that the one or more of the plurality of workloads should transition from the first host IHS to the second host IHS based, at least in part, on the specifications of the first and second host IHSs, the at least one network connectivity parameter of the first host IHSs, and the at least one network connectivity parameter of the second host IHSs; and
transition, based at least in part on the determination, the one or more of the plurality of workloads from the first host IHS to the second host IHS.

6. The IHS of claim 1, wherein to transition the one or more of the plurality of workloads from the first host IHS to the second host IHS, the program instructions further cause the processor to:
obtain, from an agent of the first host IHS, information regarding a need to transfer at least one workload of the plurality of workloads of the first host IHS to a different IHS; and
transition, based at least in part on the obtained information, the specifications of the first and second host IHSs, and the network connectivity parameters of the second host IHSs, the one or more workloads from the first host IHS to the second host IHS.

7. The IHS of claim 1, wherein the specifications of the first host IHS comprise data regarding the plurality of workloads hosted by the first host IHS, and wherein to transition the one or more of the plurality of workloads from the first host IHS to the second host IHS, the program instructions further cause the processor to:
determine workload compatibility of the plurality of workloads with the second host IHS based, at least in part, on the data regarding the plurality of workloads hosted by the first host IHS and the specifications of the second host IHSs; and
transition, based, at least in part, on the determination and the network connectivity parameters of the second host IHSs, the one or more workloads from the first host IHS to the second host IHS.

8. The IHS of claim 1, wherein the specifications of the first host IHS comprise data regarding the plurality of workloads hosted by the first host IHS, and wherein to transition the one or more of the plurality of workloads from the first host IHS to the second host IHS, the program instructions further cause the processor to:
determine that at least one of the plurality of workloads hosted by the first host IHS is not compatible with the second host IHS based, at least in part, on the data regarding the plurality of workloads hosted by the first host IHS and the specifications of the second host IHSs; and
fail to transition, based at least in part on the determination, the at least one workload from the first host IHS to the second host IHS.

9. The IHS of claim 1, wherein the plurality of workloads hosted by the first host IHS comprise a workspace of the first host IHS, and wherein to transition the one or more of the plurality of workloads from the first host IHS to the second host IHS, the program instructions further cause the processor to:
transition the entire workspace of the first host IHS to the second host IHS.

10. A method for distributing workloads across devices based on network conditions, the method comprising:
obtaining, from a plurality of host Information Handling Systems (IHSs), a respective plurality of specifications of the respective host IHSs, including specifications of a first host IHS and specifications of a second host IHS, wherein the first host IHSs hosts a plurality of workloads;
obtaining, from one or more of the plurality of host IHSs including the second host IHS, a respective one or more network connectivity parameters of the one or more host IHSs, including at least one network connectivity parameter from the second host IHS; and
transitioning one or more of the plurality of workloads from the first host IHS to the second host IHS based, at least in part, on the specifications of the first host IHS, the specifications of the second host IHS, and the network connectivity parameters of the second host IHS.

11. The method of claim 10, wherein the obtaining, from the one or more host IHSs the respective one or more network connectivity parameters of the one or more host IHSs, further comprises:
obtaining, from the first host IHS, at least one network connectivity parameter of the first host IHS; and
wherein the transitioning the one or more of the plurality of workloads, from the first host IHS to the second host IHS, further comprises:
determining that the one or more of the plurality of workloads should transition from the first host IHS to the second host IHS based, at least in part, on the specifications of the first and second host IHSs, the at least one network connectivity parameter of the first host IHSs, and the at least one network connectivity parameter of the second host IHSs; and
transitioning, based at least in part on the determination, the one or more of the plurality of workloads from the first host IHS to the second host IHS.

12. The method of claim 10, wherein the transitioning the one or more of the plurality of workloads from the first host IHS to the second host IHS further comprises:
obtaining, from an agent of the first host IHS, information regarding a need to transfer at least one workload of the plurality of workloads of the first host IHS to a different IHS; and
transitioning, based at least in part on the obtained information, the specifications of the first and second host IHSs, and the network connectivity parameters of the second host IHSs, the one or more workloads from the first host IHS to the second host IHS.

13. The method of claim 10, wherein the specifications of the first host IHS comprise data regarding the plurality of workloads hosted by the first host IHS, and wherein the transitioning the one or more of the plurality of workloads from the first host IHS to the second host IHS further comprises:
determining workload compatibility of the plurality of workloads with the second host IHS based, at least in part, on the data regarding the plurality of workloads hosted by the first host IHS and the specifications of the second host IHSs; and
transitioning, based, at least in part, on the determination of workload capability, and the network connectivity parameters of the second host IHSs, the one or more workloads from the first host IHS to the second host IHS.

14. The method of claim 10, wherein the specifications of the first host IHS comprise data regarding the plurality of workloads hosted by the first host IHS, and wherein the transitioning the one or more of the plurality of workloads from the first host IHS to the second host IHS further comprises:
determining that at least one of the plurality of workloads hosted by the first host IHS is not compatible with the second host IHS based, at least in part, on the data regarding the plurality of workloads hosted by the first host IHS and the specifications of the second host IHSs; and
failing to transition, based at least in part on the determination, the at least one workload from the first host IHS to the second host IHS.

15. The method of claim 10, wherein the plurality of workloads hosted by the first host IHS comprise a workspace of the first host IHS, and wherein the transitioning the one or more of the plurality of workloads from the first host IHS to the second host IHS further comprises:
transitioning the entire workspace of the first host IHS to the second host IHS.

16. A memory storage device having program instructions stored thereon that, upon execution by one or more Information Handling Systems (IHSs), cause the one or more IHSs to:
obtain, from a plurality of host IHSs, a respective plurality of specifications of the respective host IHSs, including specifications of a first host IHS and specifications of a second host IHS, wherein the first host IHSs hosts a plurality of workloads;
obtain, from one or more of the plurality of host IHSs including the second host IHS, a respective one or more network connectivity parameters of the one or more host IHSs, including at least one network connectivity parameter from the second host IHS; and
transition one or more of the plurality of workloads from the first host IHS to the second host IHS based, at least in part, on the specifications of the first host IHS, the specifications of the second host IHS, and the network connectivity parameters of the second host IHS.

17. The memory storage device of claim 16, wherein to obtain, from the one or more host IHSs the respective one or more network connectivity parameters of the one or more host IHSs, the program instructions further cause the one or more IHSs to:
obtain, from the first host IHS, at least one network connectivity parameter of the first host IHS; and
wherein to transition the one or more of the plurality of workloads from the first host IHS to the second host IHS, the program instructions further cause the one or more IHSs to:
determine that the one or more of the plurality of workloads should transition from the first host IHS to the second host IHS based, at least in part, on the specifications of the first and second host IHSs, the at least one network connectivity parameter of the first host IHSs, and the at least one network connectivity parameter of the second host IHSs; and
transition, based at least in part on the determination, the one or more of the plurality of workloads from the first host IHS to the second host IHS.

18. The memory storage device of claim 16, wherein to transition the one or more of the plurality of workloads from the first host IHS to the second host IHS, the program instructions further cause the one or more IHSs to:
obtain, from an agent of the first host IHS, information regarding a need to transfer at least one workload of the plurality of workloads of the first host IHS to a different IHS; and
transition, based at least in part on the obtained information, the specifications of the first and second host IHSs, and the network connectivity parameters of the second host IHSs, the one or more workloads from the first host IHS to the second host IHS.

19. The memory storage device of claim 16, wherein the specifications of the first host IHS comprise data regarding the plurality of workloads hosted by the first host IHS, and wherein to transition the one or more of the plurality of workloads from the first host IHS to the second host IHS, the program instructions further cause the one or more IHSs to:
determine workload compatibility of the plurality of workloads with the second host IHS based, at least in part, on the data regarding the plurality of workloads hosted by the first host IHS and the specifications of the second host IHSs; and
transition, based, at least in part, on the determination and the network connectivity parameters of the second host IHSs, the one or more workloads from the first host IHS to the second host IHS.

20. The memory storage device of claim 16, wherein the specifications of the first host IHS comprise data regarding the plurality of workloads hosted by the first host IHS, and wherein to transition the one or more of the plurality of workloads from the first host IHS to the second host IHS, the program instructions further cause the one or more IHSs to:
determine that at least one of the plurality of workloads hosted by the first host IHS is not compatible with the second host IHS based, at least in part, on the data regarding the plurality of workloads hosted by the first host IHS and the specifications of the second host IHSs; and
fail to transition, based at least in part on the determination, the at least one workload from the first host IHS to the second host IHS.
